(19) United States
(12) Patent Application Publication
(10) Pub. No.: US 2016/0258079 A1
(43) Pub. Date: Sep. 8, 2016

(54) METHOD AND APPARATUS FOR REMOVING RESIDUE FROM ELECTROCOATED ARTICLES

(71) Applicant: TKS Industrial Company, Troy, MI (US)

(72) Inventors: Mark J. Sweeney, Hilliard, OH (US); William Eddie Barnett, Dublin, OH (US)

(73) Assignee: TKS Industrial Company, Troy, MI (US)

(21) Appl. No.: 14/638,260

(22) Filed: Mar. 4, 2015

(51) Int. Cl. C25D 13/22; C25D 13/20; B65G 49/02; C25D 13/12

(52) U.S. Cl. CPC C25D 13/22; C25D 13/12; C25D 13/20; B65G 49/02

(57) ABSTRACT

A system and method for developing a defect-free or reduced-defect electrophoretic coating on an electrically conductive substrate involves vibrating the substrate to remove residual paint solids after the substrate has been removed from the electrophoretic deposition bath and before the electrophoretically deposited coating is cured.

### CROSS-REFERENCE TO RELATED APPLICATIONS

Not applicable.

### FIELD OF THE DISCLOSURE

This disclosure relates to methods and apparatuses for coating an electrically conductive surface, and more particularly to such methods and apparatuses that produce electrophoretic coatings with fewer or less frequent defects.

### BACKGROUND OF THE DISCLOSURE

Electrophoretic coating has become a preferred method of applying primer, protective and/or aesthetic coatings to electrically conductive surfaces of automobile and truck body components, and is often used on tractors and other farm equipment; cranes, bulldozers, earthmovers, graders and other heavy equipment; appliance components such as refrigerator condensers; metal furniture; switch gear; and other products. For example, electrophoretic primer coatings are applied to components of substantially all mass produced trucks and cars. Electrophoretic deposition (EPD) has proven to provide durable, corrosion resistant aesthetically pleasing finishes at a lower cost than other alternatives, such as powder coating, in a variety of applications. Recognized advantages include very uniform coating thickness, low porosity, and the ability to coat objects having a complex shape. Additionally, electrophoretic coating processes are easy to control and offer high product throughput, with modern EPD processes being significantly more environmentally friendly than many other coating techniques.

Typical EPD processes generally include a surface pre-treatment to enhance adhesion between the surface of a component and the coating, submerging the pre-treated component in an electrophoretic deposition bath and applying a direct current through the bath, rinsing the coated component to remove undeposited material from the EPD bath, and baking or curing the coated component to effect crosslinking of the paint film.

Although EPD processes provide very uniform coating thickness, there can be a tendency for paint solids (resin and/or pigments) that are not bonded to the surface being coated to be retained on the surface by residual water drops that can adhere to certain surfaces of an electrophoretically coated surface. When such drops remain on the coated surface during baking or curing, the paint solids in the drops can become cured to and strongly adhered to the surface of the coated article creating a coating defect. As a consequence, repair booths are a common feature at the end of an EPD production line, where defects are removed and polished using abrasives. Because such repairs are not currently amenable to robotics, there is a significant amount of labor associated with such necessary repairs. Additionally, the repair booths require a significant amount of production floor space adding further to costs associated with EPD processes. While EPD processes are already cost effective, it is desirable to improve the process and further reduce costs by eliminating or reducing the incidence of coating defects requiring repair by reducing or eliminating residual drops on the surface of an EPD coated article.

Residual drops can be removed from an EPD coating using blowers or compressed air. However, blowers and compressed air tend to propel dust and other small particles that can be embedded into the coating degrading desirable aesthetic and functional properties of the coating; and have therefore been deemed unsatisfactory.

A technique that has achieved a small or marginal amount of success from a cost to benefit perspective involves tilting the coated article in one or more directions after it has left the EPD bath to cause residual drops to run off certain surfaces (e.g., normally upwardly facing surfaces). A more efficient and cost effective solution is desired for many applications.

Another technique for removing residual drops from an EPD coated article is to dry the coated article before baking or curing the coating. These techniques can be effective for removing residual drops from the surface of the coated article. However, these techniques are not particularly cost effective because they require an enormous amount of floor space, particularly if ambient air drying is used, and can require a significant amount of energy consumption, such as when a preheat oven (at a temperature below the baking or curing temperature) is used.

### SUMMARY OF THE DISCLOSURE

Disclosed is a process for forming a cured electrophoretically deposited coating on an article having an electrically conductive surface by submerging the surface of the article in an electrophoretic deposition bath while maintaining an electrical potential through the bath between the electrically conductive surface, which acts as one of the electrodes, and a counter-electrode located in the bath in spaced relation to the electrically conductive surface of the article; removing the article after it has been electrophoretically coated; and vibrating the coated article after it has been removed from the electrophoretic deposition bath to remove residual bath drops from the coated surface before the coating is cured by heating in an oven. The step of vibrating the coated article before oven curing removes residual bath drops that might otherwise be present on the surface during curing, thereby eliminating or substantially reducing coating defects requiring repair, while requiring significantly less floor space than is needed for conventional techniques for mitigating coating defects caused by residual bath drops retained on coated surfaces during curing. The use of a vibrator to remove residual bath drops before curing also requires substantially less energy than the known use of a pre-curing oven.

Also disclosed is a system for forming a cured electrophoretically deposited coating on an article having an electrically conductive surface that includes an electrophoretic deposition bath; an overhead conveyor for transporting the article through the electrophoretic deposition bath; at least one vibrator adapted to directly contact the article or to directly contact a support structure for the article; and an oven for curing an electrophoretically deposited coating on the article.

### BRIEF DESCRIPTION OF THE DRAWINGS

FIG. 1 is a schematic diagram showing a system in accordance with this disclosure for forming a cured electrophoretically deposited coating on an electrically conductive surface of an article.

FIG. 2 is an elevational side view of an electrophoretically coated automobile body temporarily supported on a structure for vibrating the automobile body before passing it through an oven to cure the coating.

### DETAILED DESCRIPTION

The disclosed process and systems for forming a cured electrophoretically deposited coating on an electrically conductive surface of an article can be advantageously employed in a variety of EPD applications in which coating defects are caused by residual bath drops retained on coating surfaces during curing. Additionally, the disclosed process and systems are expected to expand the applicability of EPD processes to articles that were not amenable to an EPD process due to excessive coating defects.

The term “electrophoretic deposition” is intended to include a variety of processes in which charged colloidal solids from a bath are deposited onto an electrically conductive surface of an article submerged or immersed in the bath by virtue of an electrical potential imposed between the electrically conductive surface and a counter-electrode located in the bath in spaced relation to the electrically conductive surface of the article. Electrophoretic deposition processes generally encompass electrocoating, e-coating, cathodic electrodeposition, anodic electrodeposition, electrophoretic coating, and electrophoretic painting.

The electrophoretic deposition bath is a colloidal suspension that can generally comprise about 80% to 90% water and about 10% to 20% paint solids (weight basis). The paint solids are comprised of resins and optional pigments that are capable of carrying a charge and having a colloidal particle size (i.e., approximately 1 to 1000 nanometers in diameter). The solids can sometimes include other materials such as dyes, ceramics and/or metals capable of carrying a charge. The term “colloidal suspension” means that the water and solid particles form a homogenous mixture in which the behavior of the dispersed solids is predominately determined by the surface chemistry of the colloidal suspension, such that settling either does not occur or only appreciably occurs after a very long time. Examples of crosslinkable polymer resins that can carry a charge, and are therefore useful for EPD processes include epoxy resins such as diglycidal ethers of bisphenol A, and acrylic resins such as polymers of acrylic acid esters or methacrylic acid esters.

Suitable bath components, chemistries, bath temperatures, electrical potentials, counter-electrode materials and geometry, bath vessel geometry, residence times, and other EPD processing parameters are well known in the art and/or can be determined without undue experimentation using routine testing and optimization procedures, and do not constitute novel aspects of this disclosure.

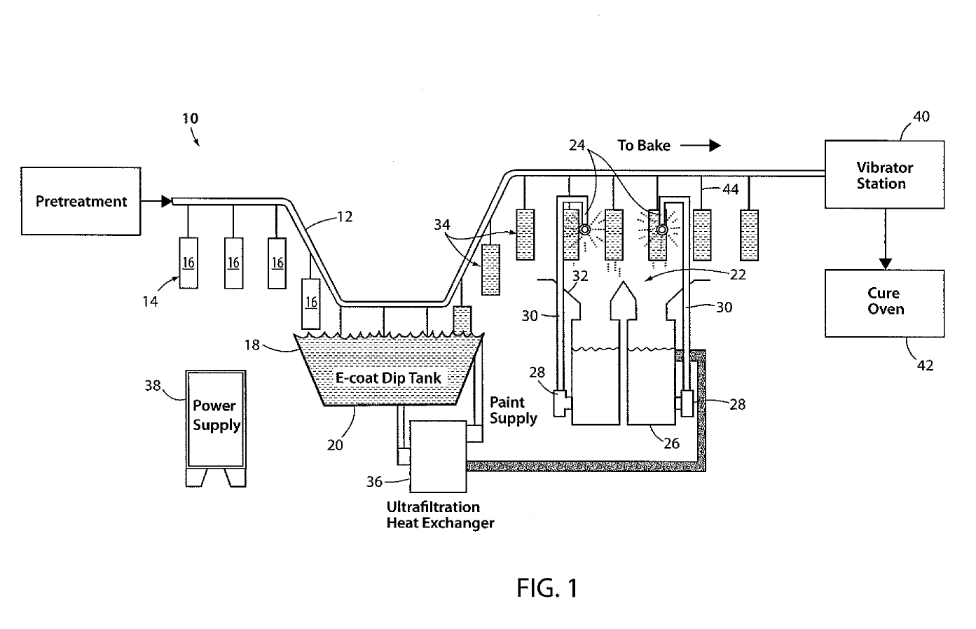

FIG. 1 diagramatically illustrates an electrophoretic deposition system 10 in accordance with certain aspects of this disclosure. System 10 includes an overhead conveyor 12 that transports non-coated articles 14 having a surface 16 that is to be coated from a pretreatment station (not shown) to an electrophoretic deposition bath 18 contained in a vessel or tank 20, through bath 18, and optionally through a rinse station 22 comprising one or more spray nozzles 24, one or more collection tanks 26, associated pumps 28, piping 30, and rinse collection surfaces 32 for recirculating rinse water from the tanks, to the nozzles, on to coated articles 34, and back to the tanks.

Pretreatment typically involves cleaning the surfaces 14 of article 12 that are to be clear coated or painted (dyed and/or pigmented) to remove dirt, oil, grease, etc.; and applying a phosphate conversion coating (e.g., a zinc phosphate, manganese phosphate, or iron phosphate) such as by immersion or spraying in order to improve corrosion resistance, lubricity and adhesion with the subsequently applied coating. Suitable detergent or cleaning solutions, techniques, and equipment are well known and commercially available, and do not constitute a novel aspect of this disclosure.

An ultrafiltration heat exchanger unit 36 is typically used to recover paint solids (e.g., colloidal resin and pigment particles) that are removed from coated articles 34 at the rinse station 22 and return the paint solids to the bath 18, and to control the temperature of the bath.

A power supply 38 supplies a direct current (DC) electric charge to the bath to induce movement of the charged paint solids toward the surface 16 that is to be coated and binding of the paint solids to the surface 16.

In accordance with certain novel aspects of this disclosure, the coated articles 34 are transported to a vibration station 40 to remove residual bath drops from the coating surface. It is difficult to rinse all of the paint solids that are loosely adhered to the coating, but which are not bonded to the underlying electroconductive interface 16 of the article, particularly with larger articles and/or articles having complex surface geometry. By vibrating articles 34 before transporting the articles to a curing oven 42, a substantial reduction in residual paint solids and associated coating defects can be economically achieved. The articles 34 can be vibrated while they are suspended from overhead conveyor 12 such as by directly contacting the vibrator with each article or a hanger 44 from which the article is suspended. Alternatively, the articles 34 can be transferred to a floor conveyor and vibrated while supported on the floor conveyor, such as by directly contacting the vibrator with each article or with a portion of the conveyor structure supporting the article.

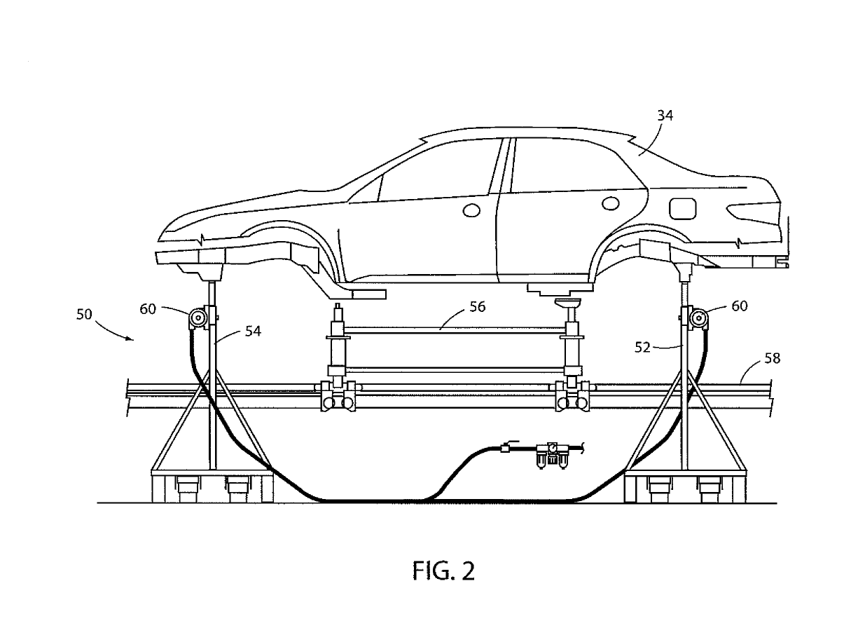

FIG. 2 illustrates another alternative vibration station 50 in which the article 34 (e.g., an automobile body) is supported on jacks 52, 54 during a step of vibrating article 34 to remove residual paint solids. Article 34 is shown lifted so that it is not supported by conveyor carrier 56 of conveyor 58. Vibrators 60 are rigidly secured to a vertical member of each of jacks 52 and 54. After article 34 has been raised of off conveyor carrier 56, vibrators 60 are energized for a short period of time (typically a matter of seconds) sufficient to substantially reduce residual solids on the article. In the illustrated vibration station 50, pneumatic vibrators are used. Alternatively, electric or hydraulic vibrators can be used. Suitable vibrators include those of the type conventionally used for material handling equipment as conveyors, bins, hoppers, chutes, etc. Vibrators can be selected to provide a stroke length or amplitude of about 0.25 inches (6 mm) to about 0.5 inches (12 mm) at a frequency of about 600 to about 800 RPM. However, different stroke lengths and frequencies outside of these ranges are possible.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

What is claimed is:

1. A process for forming a cured electrophoretically deposited coating on an article having an electrically conductive surface, comprising:
submerging the surface of an article that is to be coated in an electrophoretic deposition bath while maintaining an electrical potential through the bath using a conductive surface of the article as a first electrode and a counter-electrode spaced from the conductive surface to form a coating on the surface;
removing the coated article from the electrophoretic deposition bath;
heating the coating for a time and at a temperature that are sufficient to cure the coating; and
vibrating the article after removing the article from the bath, but before heating to cure the coating, to remove residual bath drops from the coating surface.

2. The process of claim 1, in which the surface of the article that is to be coated is spray cleaned or immersion cleaned with a detergent solution and optionally rinsed before submerging the surface of the article in the electrophoretic deposition bath.

3. The process of claim 1, in which a phosphate coating is applied to the surface of the article that is to be coated before the surface of the article is submerged in the electrophoretic deposition bath.

4. The process of claim 1, in which the surface of the article that is to be coated is rinsed after removing the coated article from the electrophoretic deposition bath, but before curing the coating.

5. The process of claim 1, in which at least one pneumatic vibrator is used for vibrating the article.

6. The process of claim 1, in which at least one electric vibrator is used for vibrating the article.

7. The process of claim 5, in which the vibrator is in direct contact with a structure supporting the article.

8. The process of claim 7, in which the structure supporting the article is a conveyor.

9. The process of claim 6, in which the vibrator is in direct contact with a structure supporting the article during vibration of the article.

10. The process of claim 9, in which the structure supporting the article is a conveyor.

11. The process of claim 5, in which the vibrator is in direct contact with the article during vibration of the article.

12. The process of claim 6, in which the vibrator is in direct contact with the article during vibration of the article.

13. A system for forming a cured electrophoretically deposited coating on an article having an electrically conductive surface, comprising:
an electrophoretic deposition bath;
an overhead conveyor for transporting an article through and out of the electrophoretic deposition bath;
at least one pneumatic or electric vibrator adapted to directly contact the article or directly contact a support structure for the article; and
an oven for curing an electrophoretically deposited coating on the article.

14. The system of claim 13, further comprising a rinse station for rinsing coated articles prior to curing in the oven.

15. The system of claim 13, further comprising a floor conveyor for transporting the article through the oven.

16. The system of claim 13, further comprising a stationary structure for temporarily supporting the article during operation of the vibrator.

17. The system of claim 16, in which the vibrator is supported on the stationary structure.
